(19) United States
(12) Patent Application Publication
(10) Pub. No.: US 2023/0222428 A1
(43) Pub. Date: Jul. 13, 2023

(54) SYSTEM AND METHOD FOR IDENTIFYING NONADHERENCE TO CONTACT CENTER PRACTICE RULES

(71) Applicant: NICE LTD., Ra'anana (IL)

(72) Inventors: Ashadeepa DEBNATH, Pune (IN); Jason Williams, Sandy, UT (US); Rahul Vyas, Jodhpur (IN); Salil Dhawan, Pune (IN)

(21) Appl. No.: 17/571,770

(22) Filed: Jan. 10, 2022

(51) Int. Cl. G06Q 10/06; H04M 3/51

(52) U.S. Cl. CPC G06Q 10/06395; G06Q 10/06393; H04M 3/5175; H04M 3/5141

(57) ABSTRACT

A computerized-method for identifying nonadherence to contact-center practice rules is provided herein. The computerized-method includes operating a data-analyzer module. The said data-analyzer module includes: (i) retrieving a set of rules; (ii) monitoring activities of each user via one or more product-applications by receiving a stream of data related to the activities from the one or more applications. The stream of data may include details of the monitored activities; (iii) comparing details of the monitored activities with each rule in the set of rules to identify one or more activities that are breaching a rule from the set of rules; (iv) for each activity of a related-user from the identified one or more activities: (a) notifying the related-user about a guideline-breaching via a computerized-device of the related-user; and (b) updating the data store of exceptions with the details of the activity that breached the rule from the set of rules.

### TECHNICAL FIELD

The present disclosure relates to the field of data analysis and more specifically to identifying nonadherence of users to contact center practice rules.

### BACKGROUND

In contact centers, best practices of users, such as agents, supervisors, managers and evaluators are a complicated set of metrics that are commonly monitored by a human. For example. Average Speed of Answer (ASA), Average Talk Time (ATT), overall Average Handle Time (AHT) are key metrics of agents that are monitored via a dashboard interface of an application. However, monitoring the set of metrics is operated along with verifying other operations such as, call recordings are operated with the correct regularity, agents are not overloaded with tasks, self-service Interactive Voice Responses (IVR)s are capturing the right number of contacts, quality scores are at the right level and the like.

Determining whether a contact center is adhering to a set of rules of best practices of users is currently performed manually, if performed at all and diagnosing this complex cause and effect is very time consuming.

A set of rules of best practices of agents vary widely from contact center to contact center and sometimes even from team to team, in the same contact center, depending on how they operate. Companies spend a lot of money on research and analysis of organizations to help them build and apply best practices.

To improve Customer Satisfaction Score (CSAT) and to reduce the cost per contact, there is a need for a technical solution that will automatically analyze adherence to best practices to generate revenue in the following areas: a. product revenue; b. implementation revenue for initial setup; and c. consulting revenue to provide consulting on best practices.

Furthermore, there is a need for a system and method to enable a contact center to create a set of rules of best practices to allow them to identify which teams or agents are adhering to the preconfigured set of rules of best practices.

### SUMMARY

There is thus provided, in accordance with some embodiments of the present disclosure, a computerized-method for identifying nonadherence to contact center practice rules in a contact center.

Furthermore, in accordance with some embodiments of the present disclosure, in a computerized system that may include one or more processors, and a memory including a data store of practice rules and a data store of exceptions, the one or more processors may operate a data-analyzer module.

Furthermore, in accordance with some embodiments of the present disclosure, the data-analyzer module may include: (i) retrieving a set of rules from the data store of practice rules; (ii) monitoring activities of each user via one or more product-applications in the contact center by receiving a stream of data related to the activities from the one or more applications. The stream of data may include details of the monitored activities; (iii) comparing details of the monitored activities with each rule in the set of rules to identify one or more activities that are breaching a rule from the set of rules; (iv) for each activity of a related user from the identified one or more activities: (a) notifying the related user about a guideline breaching via a computerized-device of the related user; and (b) updating the data store of exceptions with the details of the activity that breached the rule from the set of rules.

Furthermore, in accordance with some embodiments of the present disclosure, the computerized-method may further include operating a generator module to enable a configuration of the set of rules for each product-application, wherein each rule has a threshold per activity and role to be stored on the data store of practice rules.

Furthermore, in accordance with some embodiments of the present disclosure, the configuration of the set of rules for each product-application may be operated via a User-interface (UI).

Furthermore, in accordance with some embodiments of the present disclosure, the notifying may be operated by sending a message with details of the activity of the related user, to be displayed via a display unit that is associated to a computerized-device of the related user.

Furthermore, in accordance with some embodiments of the present disclosure, the retrieved set of rules may be stored in a cache for a preconfigured period.

Furthermore, in accordance with some embodiments of the present disclosure, the details of the monitored activities may include at least one of: (i) product-application; (ii) activity; and (iii) role of user.

Furthermore, in accordance with some embodiments of the present disclosure, when a user may select a period via a User-interface (UI), the computerized-method may further include operating a data utilizer module to generate a report with details of activities that breached the set of rules, and wherein said data utilizer module is generating the report by retrieving data from the data store of exceptions, according to the selected period, to be displayed via a display unit.

Furthermore, in accordance with some embodiments of the present disclosure, after a preconfigured number of notifications to a user, the computerized-method may further include operating an activity breaker module to change a role of the related user.

There is further provided, in accordance with some embodiments of the present disclosure, a computerized-system for identifying nonadherence of to contact center practice rules in a contact center.

Furthermore, in accordance with some embodiments of the present disclosure, the computerized-system may include: one or more processors and a memory including a data store of practice rules and a data store of exceptions. The one or more processors may be configured to operate a data-analyzer module. The data-analyzer module may include: (i) retrieving a set of rules from the data store of practice rules; (ii) monitoring activities of each user via one or more product-applications in the contact center by receiving a stream of data related to the activities from the one or more applications. The stream of data may include details of the monitored activities; (iii) comparing details of the monitored activities with each rule in the set of rules to identify one or more activities that are breaching a rule from the set of rules; (iv) for each activity of a related user from the identified one or more activities: (a) notifying the related user about a guideline breaching via a computerized-device of the related user; and (b) updating the data store of exceptions with the details of the activity that breached the rule from the set of rules.

### BRIEF DESCRIPTION OF THE DRAWINGS

FIG. 1A schematically illustrates a high-level diagram of a system for identifying nonadherence to contact center practice rules, in accordance with some embodiments of the present disclosure;

FIG. 1B schematically illustrates a high-level diagram of a system for configuring practice rules, identifying nonadherence to contact center practice rules and reporting thereof, in accordance with some embodiments of the present disclosure;

FIG. 2 illustrates an example of a set of rules for one or more product-applications, in accordance with some embodiments of the present disclosure;

FIG. 3 is a high-level workflow of a data-analyzer module, in accordance with some embodiments of the present disclosure; and

FIG. 4 shows an example of a user-interface for generating a report with details of activities that breached the set of rules, in accordance with some embodiments of the present disclosure; and

FIGS. 5A-5C are examples of notifications that are sent to users that breached the set of rules, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

According to some embodiments of the present disclosure, by providing a technical solution to a contact center that enables the contact center to adhere to industry's best practices, assisting the contact center to increase quality of service to customers, while ensuring high efficiency and reducing overheads.

The term “related user” as used herein refers to a user that either operated the activity or a user that is interested in a notification when one or more rules are breached.

The term “best practice” as used herein refers to a set of practice rules which are contact center metrics and Key Performance Indicator (KPI) to measure performance. For example, Net Promoter Score (NPS), Customer Satisfaction (CSAT), First Response Time (FRT), Average Handling Time (AHT), Average Speed of Answer (ASA), Average Talk Time (ATT), actions related to: shift scheduling, coaching, performance evaluation, call recording and the like.

These practices hold huge significance as they have wide industry acceptance and contribute significantly to improved customer satisfaction, increased agent engagement and credible quality processes.

Currently, contact centers lack a system and a method to implement and automate best practice enforcement, and receive notifications of nonadherence to best practice, as well as to generate automated reports including information and suggestions to increase contact center efficiency.

Accordingly, there is a need for a system and method to identify nonadherence to contact center practice rules e.g., best practices, in a contact center.

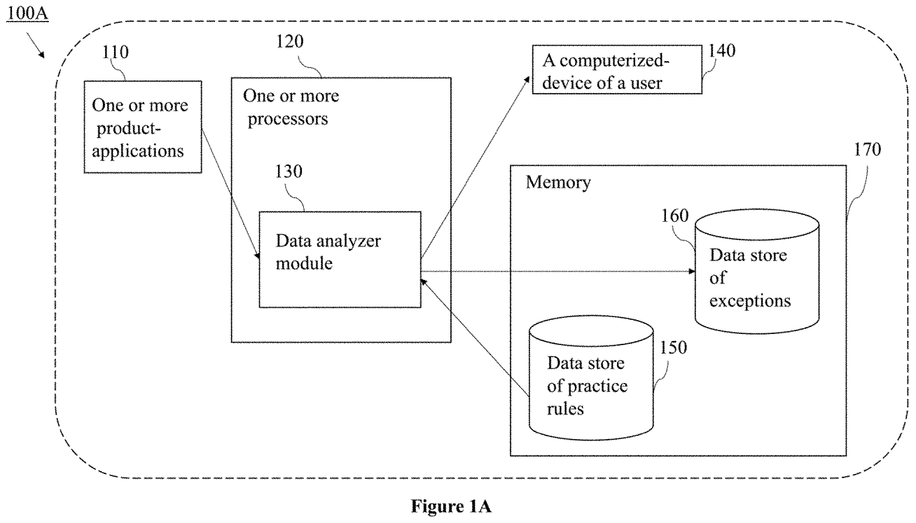

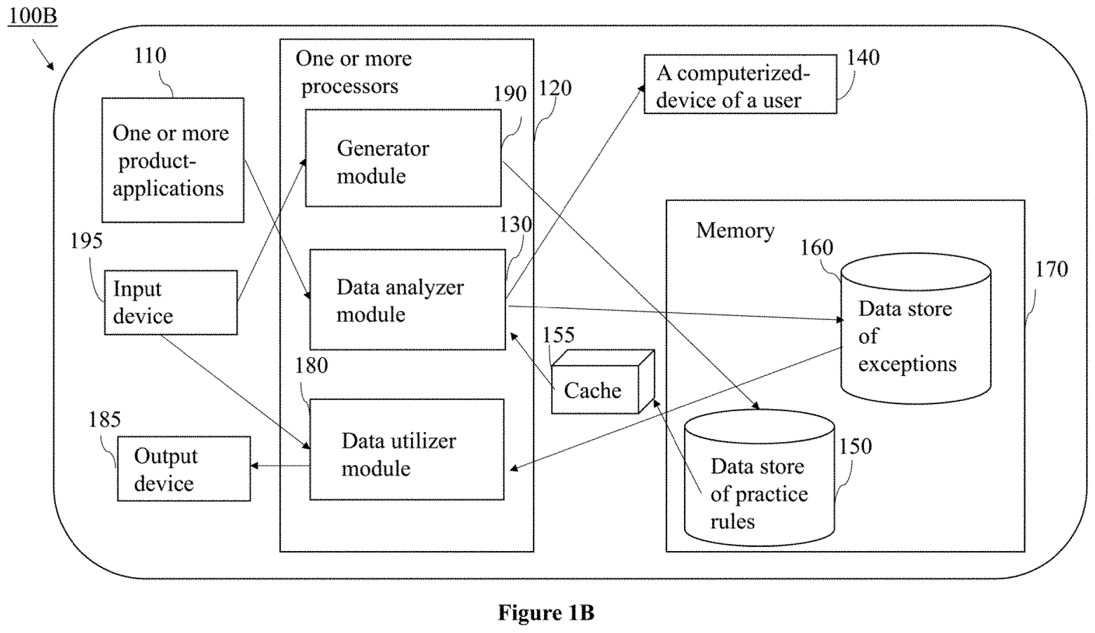

FIG. 1A schematically illustrates a high-level diagram of a system 100A for identifying nonadherence to contact center practice rules, in accordance with some embodiments of the present disclosure.

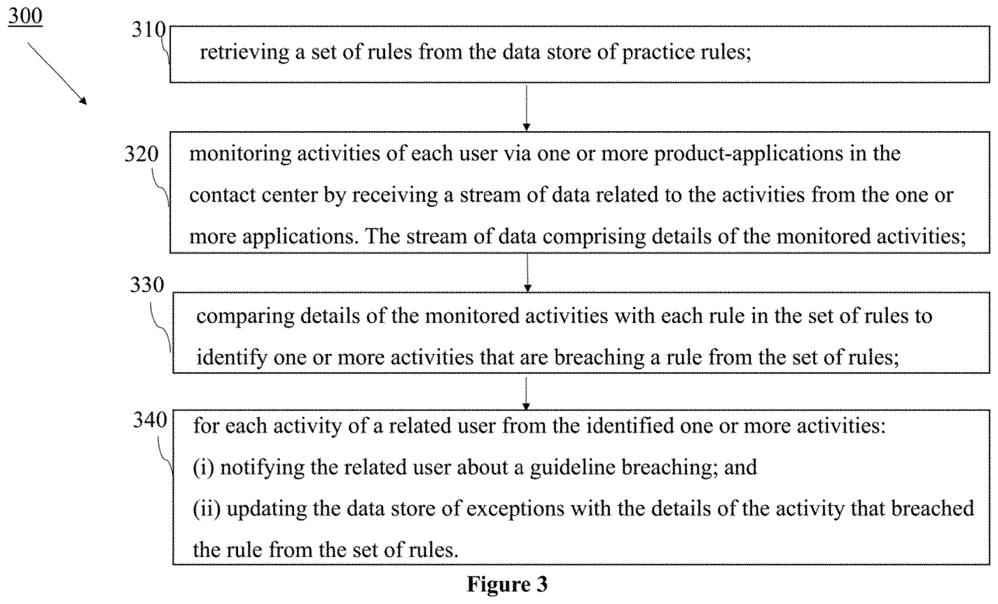

According to some embodiments of the present disclosure, in a computerized-system, such as system 100A, which may include one or more processors 120, and a memory 170 including a data store of practice rules 150 and a data store of exceptions 150, the one or more processors may operate a module, such as a data-analyzer module 130 and such as data-analyzer module 300 in FIG. 3.

According to some embodiments of the present disclosure, the data-analyzer module 130 may include: (i) retrieving a set of rules from a data store, such as the data store of practice rules 150; and (ii) monitoring activities of each user via one or more product-applications 110 in the contact center by receiving a stream of data related to the activities from the one or more applications 110.

According to some embodiments of the present disclosure, the stream of data related to the activities from the one or more applications 110 may include details of the monitored activities. For example, product-application, activity and the role of user. The one or more applications 110 may be for example, Workforce Management (WFM), Quality Management (QM) or recording.

According to some embodiments of the present disclosure, the data-analyzer module 130 may also include comparing details of the monitored activities with each rule in the retrieved set of rules to identify one or more activities that are breaching a rule from the set of rules. For each activity of a related user from the identified one or more activities: (i) notifying the related user about a guideline breaching by sending a message to a computerized-device of the user 140; and (ii) updating the data store of exceptions 160 with the details of the activity that breached the rule from the set of rules.

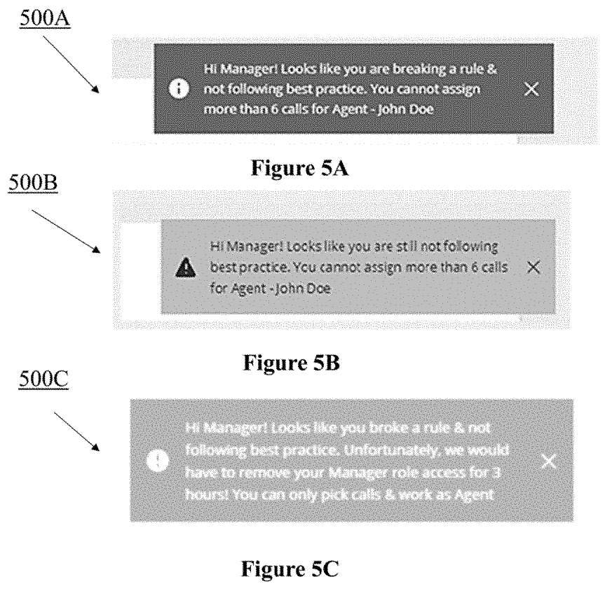

According to some embodiments of the present disclosure, the data-analyzer module 130 may provide a feedback to a computerized-device of the user 140, that breached a rule. The notifying may be operated by sending a message with details of the activity of the related user, to be displayed via a display unit that is associated to the computerized-device of the related user 140. For example, as shown in messages 500a-500C in FIGS. 5A-5C, so that the user and the system 100A may take an action.

According to some embodiments of the present disclosure, for example, when data as to an activity, such as an agent's scheduled break, may be streamed from an application, such as WFM application 140 to the data analyzer module 130 and a rule in the set of rules may be for example, that an agent cannot prolong a scheduled break, then nonadherence of an agent to such a rule, e.g., when an agent prolongs a scheduled break, the data-analyzer module 130 may send a ‘warning’ notification to the agent and also a corresponding notification may be sent to the agent's supervisor.

According to some embodiments of the present disclosure, the notification message when the rule is breached, which may be sent to the supervisor and agent, may be as follows: “Hello Supervisor. Agent has initiate prolonging an original scheduled break time” and “Hello Agent, you are not allowed to extend a scheduled break time.”

FIG. 1B schematically illustrates a high-level diagram of a system 100B for configuring practice rules, identifying nonadherence to contact center practice rules and reporting thereof, in accordance with some embodiments of the present disclosure.

According to some embodiments of the present disclosure, system 1003 includes all the elements of system 100A: one or more product-applications 110, one or more processors 120, data-analyzer module 130, a computerized-device of the user 140, data store of practice rules 150, data store of exceptions 160 and memory 170.

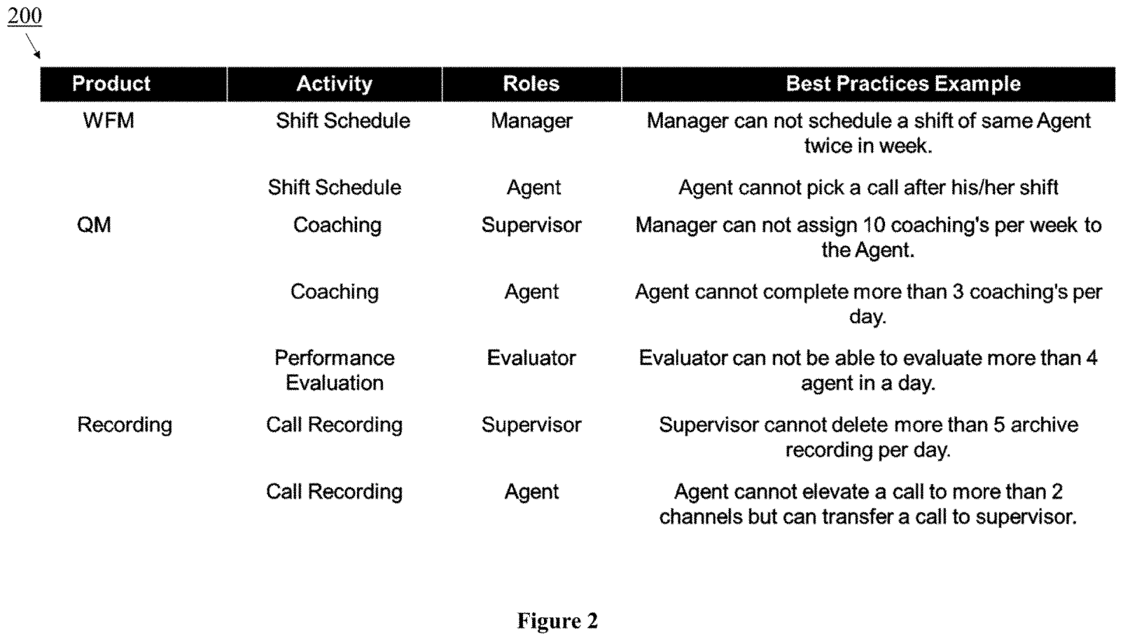

According to some embodiments of the present disclosure, system 100B may further include a module, such as a generator module 190 to enable a configuration of the set of rules for each product-application of the one or more product-applications 110. Each rule has a threshold per activity and role to be stored on the data store of practice rules 150, for example, as shown in the example 200 of a set of rules for one or more product-applications in FIG. 2.

After selecting best practices for a given product an administrator can select best practices e.g., a rule for a certain activity that is defined for a product, and a related threshold for a given best practices and then either save or update certain rules in the database.

For example, for activity such as evaluation, which is performed by an evaluator under QM application, an administrator can decide that best practice for the evaluator is that the evaluator should not complete more than seven evaluations on a particular day for effective evaluation. When an evaluator has completed seven evaluations, then a notification may be sent to the evaluator. Such a notification can be categorized as info, warning and error message. The threshold in this example to the evaluation activity is seven evaluations.

According to some embodiments of the present disclosure, after a preconfigured number of notifications to a user, the system 100B may operate an activity breaker module (not shown) to change a role of the related user.

For example, when an administrator configures a preconfigured number of notifications to a user, a maximum threshold for a rule to be breached, e.g., three times, it means that the notification may be sent to the evaluator three times each time the evaluator does not follow the rule, e.g., the given best practice.

According to some embodiments of the present disclosure, the configuration of the set of rules for each product-application of the one or more product-applications 110, may be operated via a User-Interface (UI), which may be associated to an input device, such as input device 195.

According to some embodiments of the present disclosure, for example, a rule could be set up to monitor Average Speed of Answer (ASA), Average Talk Time (AT), overall Average Handle Time (AHT), and call volume and combine results of customer satisfaction surveys, along with how many contacts escalated from self-service or bots. When there is a significant number of calls escalated from a self-service Interactive Voice Response (IVR) or Bot to an agent, then it may indicate that the self-service system may be experiencing issues. For example, when a user such as the administrator may receive a notification about IVR capture adherence issues it may be an indication of a failing system that has to be taken care of.

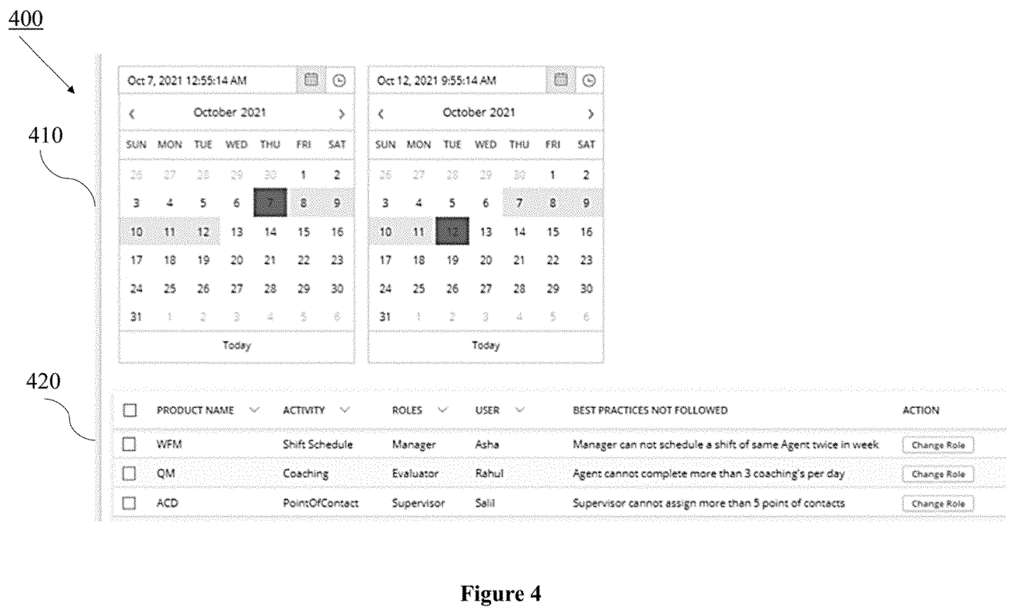

According to some embodiments of the present disclosure, in another example, a user such as administrator may be interested in IVR capture statistics and Artificial Intelligence (AI) Bot escalations to ensure that they are operating effectively. For that purpose, the administrator may configure one or more rules to be stored in the data store of practice rules 150. A user, such as the administrator may select a period via a User-Interface (UI), such as UI 400 in FIG. 4, upon which a module, such as the data utilizer module 180, may generate a report with details of activities that breached the set of rules, such as report 420 in FIG. 4. Alternatively, a user may automatically receive a message once one or more rules have been breached. The UI may be associated with an input device such as input device 195.

According to some embodiments of the present disclosure, the data utilizer module 180 may generate the report by retrieving data from a data store, such as the data store of exceptions 160, according to the selected period, to be displayed via a display unit, such as output device 185.

According to some embodiments of the present disclosure, the retrieved set of rules may be stored in a cache, such as cache 155 for a preconfigured period. After the preconfigured time, the set of rules may be retrieved directly from the data store of practice rules 150 and the cache 155 may be updated again.

According to some embodiments of the present disclosure, after a preconfigured number of notifications to a user, for example, such as messages 5A-5C in FIGS. 5A-5C, a module, such as activity breaker module, may be operated to change a role of the related user. For example, a manager may be notified several times as to a rule breach after which the manager may be downgraded from the current role for a specified period to an inferior role.

FIG. 2 illustrates an example 200 of a set of rules for one or more product-applications, in accordance with some embodiments of the present disclosure.

According to some embodiments of the present disclosure, a set of rules may include for example one or more rules related to a product-application, such as Workforce Management (WFM). When an activity, such as shift-schedule activity may be streamed from the WFM for an agent, the rule such as an agent cannot pick a call after the shift may be checked for adherence with best practice. When an agent takes a call after a scheduled shift, the data related to end of shift may be streamed from the WFM application and compared with the set of rules by the data-analyzer module 130 in FIG. 1B.

According to some embodiments of the present disclosure, the set of rules may include in another example, a rule related to a product-application, such as Quality Management (QM). When an activity, such as coaching activity may be operated for a user, QM application may stream data related to the activity to the data analyzer module 130 in FIG. 1B.

According to some embodiments of the present disclosure, a set of rules may include for example one or more rules related to a product-application, such as recording. When an activity, such as call recording may be operated by a supervisor, the supervisor cannot delete more than five archive recordings per day. In another example, a rule may be set for an agent such that an agent cannot elevate a call to more than two channels but can transfer a call to a supervisor.

According to some embodiments of the present disclosure, the recording application may stream data related to activity call recording to the data analyzer module 130 in FIG. 1B. The data related to the activity call recording may be deleting archive recordings or elevating a call to more than two channels. The data may be compared with the rules which are related to the recording application.

FIG. 3 is a high-level workflow 300 of data-analyzer module, in accordance with some embodiments of the present disclosure.

According to some embodiments of the present disclosure, operation 310 may comprise retrieving a set of rules from the data store of practice rules.

According to some embodiments of the present disclosure, operation 320 may comprise monitoring activities of each user via one or more product-applications in the contact center by receiving a stream of data related to the activities from the one or more applications. The stream of data comprising details of the monitored activities.

According to some embodiments of the present disclosure, operation 330 may comprise comparing details of the monitored activities with each rule in the set of rules to identify one or more activities that are breaching a rule from the set of rules.

According to some embodiments of the present disclosure, operation 340 may comprise for each activity of a related user from the identified one or more activities: (i) notifying the related user about a guideline breaching; and (ii) updating the data store of exceptions with the details of the activity that breached the rule from the set of rules.

FIG. 4 shows an example of a user-interface 400 for generating a report with details of activities that breached the set of rules, in accordance with some embodiments of the present disclosure.

According to some embodiments of the present disclosure, when a user is selecting a period via a calendar date selector, in a User-Interface (UI), such as calendar date selector 410 in 1I 400, a system, such as system 10011 may operate a module, such as data utilizer module 180 in FIG. 1I to generate a report, such as report 420. The report may be generated by retrieving data from a data store, such as the data store of exceptions 160 in FIG. 1B, according to the selected period, to be displayed via a display unit.

According to some embodiments of the present disclosure, the report may include details of activities that breached the preconfigured set of rules, which may be stored in a data store, such as data store of practice rules 150 in FIG. 1B. The report may include a product-application name, the activity, the role of user, the name of user, the rule that has been breached, e.g., the best practice that has not been followed and a button to take action. For example, the report 420 includes: product-application name, e.g., WFM, the activity e.g., shift schedule, the role of user e.g., Manager, the name of user e.g., Asha, the rule that has been breached, e.g., ‘Manager cannot schedule a shift of same agent twice a week’ and a button for an option to take action e.g., change role of the user.

In another example, the report 420 includes: product-application name, e.g., QM, the activity e.g., coaching, the role of user e.g., Evaluator, the name of user e.g., Rahul, the rule that has been breached, e.g., ‘Agent cannot complete more than 3 coaching's per day’ and a button for an option to take action e.g., change role of the user.

In yet another example, the report 420 includes: product-application name, e.g., ACD, the activity e.g., point of contact, the role of user e.g., Supervisor, the name of user e.g., Salil, the rule that has been breached, e.g., ‘Supervisor cannot assign more than 5 point of contacts’ and a button for an option to take action e.g., change role of the user.

FIGS. 5A-5C are examples 500A-500C of notifications that are sent to users that breached the set of rules, in accordance with some embodiments of the present disclosure.

According to some embodiments of the present disclosure, after a preconfigured number of notifications to a user, the system, such as system 100B may operate an activity breaker module to change a role of the related user.

According to some embodiments of the present disclosure, a module, such as data-analyzer module 130 in FIG. 1A may compare details of the monitored activities with each rule in the set of rules to identify one or more activities that are breaching a rule from the set of rules. For each activity of a related user from the identified one or more activities: (i) notifying the related user about a guideline breaching; and (ii) updating the data store of exceptions 160 in FIG. 1A with the details of the activity that breached the rule from the set of rules.

For example, when one of the rules in the set of rules in the contact center, e.g., best practice, is that a manager cannot assign more than 6 calls to a certain duration because the agent needs a break then, such a rule may be saved to a data store, such as data store of practice rules 150 in FIG. 1A. A maximum allowed threshold for breaking this rule, i.e., guideline breaching may be set by the contact center supervisor or admin to be three.

According to some embodiments of the present disclosure, the first notification may be for example, such as message 500A in FIG. 5A. “Hi Manager! Looks like you are breaking a rule and not following best practice. You cannot assign more than 6 calls for agent John Doe.”

According to some embodiments of the present disclosure, the second notification may be for example such as message 500B in FIG. 5B. “Hi Manager! Looks like you are still not following best practice. You cannot assign more than 6 calls for agent John Doe.”

According to some embodiments of the present disclosure, the first notifications may be for example such as message 500C in FIG. 5C. “Hi Manager! Looks like you broke a rule and not following best practice. Unfortunately, we would have to remove your Manager role for access for 3 hours! You can only pick calls and work as an agent.”

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for identifying nonadherence to contact center practice rules in a contact center, the computerized-method comprising:
in a computerized-system comprising one or more processors, and a memory including a data store of practice rules and a data store of exceptions, said one or more processors are operating a data-analyzer module, said data-analyzer module comprising:
retrieving a set of rules from the data store of practice rules;
monitoring activities of each user via one or more product-applications in the contact center by receiving a stream of data related to the activities from the one or more applications,
wherein the stream of data comprising details of the monitored activities;
comparing details of the monitored activities with each rule in the set of rules to identify one or more activities that are breaching a rule from the set of rules;
for each activity of a related user from the identified one or more activities:
(i) notifying the related user about a guideline breaching via a computerized-device of the related user; and
(ii) updating the data store of exceptions with the details of the activity that breached the rule from the set of rules.

2. The computerized-method of claim 1, wherein the computerized-method is further comprising operating a generator module to enable a configuration of the set of rules for each product-application, wherein each rule has a threshold per activity and role to be stored on the data store of practice rules.

3. The computerized-method of claim 2, wherein the configuration of the set of rules for each product-application is operated via a User-Interface (UI).

4. The computerized-method of claim 1, wherein the notifying is operated by sending a message with details of the activity of the related user, to be displayed via a display unit that is associated to a computerized-device of the related user.

5. The computerized-method of claim 1, wherein the retrieved set of rules is stored in a cache for a preconfigured period.

6. The computerized-method of claim 1, wherein the details of the monitored activities comprise at least one of: (i) product-application; (ii) activity; (iii) role of user.

7. The computerized-method of claim 1, wherein when a user is selecting a period via a User-Interface (UI), the computerized-method is further comprising operating a data utilizer module to generate a report with details of activities that breached the set of rules, and wherein said data utilizer module is generating the report by retrieving data from the data store of exceptions, according to the selected period, to be displayed via a display unit.

8. The computerized-method of claim 1, wherein after a preconfigured number of notifications to a user, the computerized-method is further comprising operating an activity breaker module to change a role of the related user.

9. A computerized-system for identifying nonadherence to contact center practice rules in a contact center, the computerized-system comprising:
one or more processors, and a memory including a data store of practice rules and a data store of exceptions,
said one or more processors are configured to operate a data-analyzer module, said data-analyzer module comprising:
retrieving a set of rules from the data store of practice rules;
monitoring activities of each user via one or more product-applications in the contact center by receiving a stream of data related to the activities from the one or more applications,
wherein the stream of data comprising details of the monitored activities;
comparing details of the monitored activities with each rule in the set of rules to identify one or more activities that are breaching a rule from the set of rules;
for each activity of a related user from the identified one or more activities:
(i) notifying the related user about a guideline breaching via a computerized-device of the related user; and
(ii) updating the data store of exceptions with the details of the activity that breached the rule from the set of rules.
